(19) United States
(12) Patent Application Publication
(10) Pub. No.: US 2026/0313651 A1
(43) Pub. Date: Oct. 8, 2026

(54) METHOD AND APPARATUS FOR DYNAMIC PANEL SELECTION FOR UPLINK TRANSMISSION

(71) Applicant: Apple Inc., Cupertino, CA (US)

(72) Inventors: Seyed Ali Akbar FAKOORIAN, San Diego, CA (US); Dawei ZHANG, Saratoga, CA (US); Wei ZENG, Saratoga, CA (US); Hong HE, San Jose, CA (US); Oghenekome OTERI, San Diego, CA (US); Chunxuan YE, San Diego, CA (US); Haitong SUN, Saratoga, CA (US)

(21) Appl. No.: 19/483,119

(22) PCT Filed: Apr. 30, 2024
(86) PCT No.: PCT/US2024/027021

§ 371 Date: Nov. 10, 2025

Related U.S. Application Data
(60) Provisional application No. 63/465,834, filed on May 11, 2023.

(51) Int. Cl. H04W 72/21; H04L 5/00; H04W 72/51

(52) U.S. Cl. CPC H04W 72/21; H04L 5/0035; H04W 72/51

(57) ABSTRACT

Embodiments relate to a method and apparatus for radio resource management (RRM) for user equipment (UE) in communication with a base station including dynamic panel selection for uplink transmission from the UE. In particular, a method and apparatus is disclosed that allows for determining a maximum number of available antenna ports per panel per band; and transmitting from the UE to the base station the maximum number of available antenna ports per panel per band.

### CROSS-REFERENCE TO RELATED APPLICATIONS

This application claims the benefit of and priority to U.S. Provisional Patent Application No. 63/465,834 filed May 11, 2023. The entirety of which is incorporated herein by reference.

### FIELD OF INVENTION

This invention relates generally to the field of wireless communication, and more particularly, to a method and apparatus for radio resource management (RRM) for user equipment (UE) in communication with a base station including dynamic panel selection for uplink transmission from the UE.

### BACKGROUND OF THE INVENTION

In a wireless communications network, user equipment (UE) may communicate with a base station of the network by establishing a radio link between the UE and the base station. In a 5G (New Radio or NR) or 4G (LTE) wireless network, a UE may receive signaling and data from the serving base station in a downlink (DL) transmission direction or transmit signaling and data to the serving base station in an uplink (UL) transmission direction.

### SUMMARY OF THE DESCRIPTION

For a UE with different number of antenna ports per panel, and for transmission toward a single transmission and reception point (TRP), the UE needs to dynamically indicate the maximum number of antenna ports corresponding to the best panel for uplink (UL) transmission to the base station. This is due to the fact that the best panel for the transmission of a given beam may change due to the rotation of the UE, etc.

In Release17 (R17), the function of “UE capability index reporting” was introduced (e.g., Section 38.822, FIG. 23-1-4 of R17). In this environment, the UE reports the maximum number of sounding reference signal (SRS) antenna ports in uplink control information (UCI) along with the L1 beam report (e.g., L1-Reference Signal Received Power (L1-RSRP)). For example, Table 6.3.1.1.2-8 of Section 38.212 of Release 17 provides for the L1-based Channel State Information (CSI) report procedure. In this procedure, the UE can report up to 4 beam indices and their corresponding L1 measurements (RSRP or Signal Interference and Noise Ratio (SINR)), and the CapabilityIndex associated with each beam, where the CapabilityIndex represents the maximum number of SRS antenna ports.

In R17, L1 based procedure for group-based beam reporting is also supported for a UE to report (up to 4) beam pairs that can be received simultaneously. R17, Section 38.822, FG 23-5-1 provides for the corresponding UE capability. For example, Table 6.3.1.1.2-8B of Section 38.212 of R17, provides for the L1 based CSI report procedure. In this procedure, the UE is configured with two channel measurement resource sets and the UE can report up to 4 beam pair (e.g., called resource group) indices, where each of two indices correspond to a pair that are associated to one codec mode request (CMR) resource sets. For each pair, the UE also reports the pair of L1-RSRPs associated to the beams in the pair.

Although these present implementations allow for the UE to indicate (through UL UCI) a maximum number of antenna ports, dynamic UL panel selection is not provided. Also, the present implementations do not allow for non-code based (NCB) physical uplink channel (PUSCH) transmission. The present implementations for UE capability index reporting are only designed to report a maximum number of SRS antenna ports, which is only used for CB based PUSCH. Furthermore, the present R17 implementation is not applied to multi-panel simultaneous UL transmission. There is no use case for a pair of best panels/beams to be reported by the UE.

As has been previously described, present implementations in Rel. 17 allow for the UE to indicate (through uplink control information (UCI)), a maximum number of antenna ports, but dynamic UL panel selection is not provided. Also, the present implementations of Rel. 17 do not allow for non-codebook based (NCB) physical uplink channel (PUSCH) transmission. The present implementation in Rel. 17 for UE capability index reporting is only designed to report a maximum number of SRS antenna ports, which is only used for code based (CB) based PUSCH. Furthermore, the present R17 implementation is not applied to multi-panel simultaneous UL transmission. There is no use case for a pair of best panels/beams to be reported by the UE.

Embodiments of the disclosure relate to the UE being able to dynamically indicate a maximum number of antenna ports for the best panel or across panels. Further, embodiments of the disclosure allow for the UE to dynamically indicate a maximum number of SRS antenna ports as part of a NCB PUSCH. Moreover, embodiments of the disclosure allow for a multi-panel simultaneous UL transmission providing a use case for a pair of best panels/beams to be reported by the UE.

In one embodiment, a method for radio resource management (RRM) for a user equipment (UE) in communication with a base station is disclosed that comprises: determining a maximum number of available antenna ports per panel per band; and transmitting from the UE to the base station the maximum number of available antenna ports per panel per band. In one embodiment, the method further includes transmitting from the UE to the base station a maximum number of available antenna ports per band across panels.

In another embodiment, a method for a UE in communication with a base station is disclosed that comprises: transmitting from the UE to the base station a UE capability index report including a maximum number of sounding reference signal (SRS) resources within a SRC resource set with usage set as non-codebook (NCB) based or a maximum number of SRS resources within a SRC resource set with usage set as codebook (CB) based.

In another embodiment, a method for a UE in communication with a base station is disclosed that comprises: configuring multiple SRS-ResourceSets with usage set to NCB at the UE or a multiple SRS-ResourceSet with usage set to CB at the UE. In one embodiment, the number of configured SRS-ResourceSets is subject to UE capability. In one embodiment, when SRS resource sets are set with usage set to CB, SRS resources within each set include the same number of SRS antenna ports, whereas different SRS resource sets include a different number of SRS resource sets. In one embodiment, when SRS resource sets are set with usage set to NCB, SRS resource sets include a different number of SRS resources within each set.

In another embodiment, a method for a UE in communication with a base station is disclosed that comprises: transmitting from the UE to the base station a dynamically determined maximum number of SRS resources for a NCB based physical uplink channel (PUSCH) corresponding to a best panel for UL transmission; or transmitting from the UE to the base station a dynamically determined maximum number of antenna ports for a CB based PUSCH corresponding to a best panel for UL transmission. In one embodiment, the dynamically determined maximum number of SRS resources or antenna ports for NCB or CB based PUSCH are based on physical layer (L1) and are transmitted to the base station in Uplink Control Information (UCI). In one embodiment, the UCI includes at least one of CRI/SSBRI, L1-RSRP/SINR, or Capability Index. In one embodiment, if the transmission is beyond UE capability the method further includes: dropping the transmission; transmitting only over antenna ports for CB or the number of SRS resources for NCB that are under the L1 report; or for aperiodic (AP)-SRS defining as an error. In one embodiment, when SRS transmissions correspond to different SRS resource sets with a different number of SRS resources for NCB based or a different number of SRS-Ports for CB based, when SRS transmissions in a particular serving cell overlap in time, the method further includes: 1) dropping both SRS transmission occasions; 2) only transmitting over the antenna ports for CB or number of SRS resources for NCB that are under the latest UE L1 capability report; or defining as an error case.

In an additional embodiment, a method for a UE in communication with a base station is disclosed that comprises: transmitting from the UE to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs). In one embodiment, the UL UCI includes a pair of trios each including a first trio and a second trio. In one embodiment, the first trio in each pair corresponds to one of the channel measurement resource sets and the second trio in each pair corresponds to the other channel measurement resource sets. In one embodiment, each trio includes at least one of: a CRI associated with the channel measurement resource set; a corresponding RSRP; and a CI associated with the particular beam. In one embodiment, the UE dynamically indicates to the base station through the UL UCI at least the CRI, the L1-RSRP, and instead of the capability index (CI), a UL/DL association. In one embodiment, a single group-based report is provided on the UL UCI that is applicable to both DL for simultaneous reception and UL for simultaneous transmission. In one embodiment, an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).

In another type of embodiment, a UE to implement radio resource management (RRM) for the UE in connection with a base station is disclosed, the UE comprising: at least one antenna port; at least one radio, wherein the at least one radio is configured to communicate with the base station using the at least one antenna port; and at least one processor coupled to the at least one radio, wherein the at least one processor is configured to perform operations comprising: determining a maximum number of available antenna ports per panel per band; and commanding transmission to the base station of the maximum number of available antenna ports per panel per band. In one embodiment, further comprising the processor commanding the transmission to the base station of a maximum number of available antenna ports per band across panels.

In an additional embodiment, a UE in connection with a base station is disclosed, the UE comprising: at least one antenna port; at least one radio, wherein the at least one radio is configured to communicate with the base station using the at least one antenna port; and at least one processor coupled to the at least one radio, wherein the at least one processor is configured to perform operations comprising: commanding transmission to the base station of a UE capability index report including a maximum number of sounding reference signal (SRS) resources within a SRC resource set with usage set as non-codebook (NCB) based or a maximum number of SRS resources within a SRC resource set with usage set as codebook (CB) based.

In another embodiment, a UE in connection with a base station is disclosed, the UE comprising: at least one antenna port; at least one radio, wherein the at least one radio is configured to communicate with the base station using the at least one antenna port; and at least one processor coupled to the at least one radio, wherein the at least one processor is configured to perform operations comprising: configuring multiple SRS-ResourceSets with usage set to NCB or a multiple SRS-ResourceSet with usage set to CB. In one embodiment, the number of configured SRS-ResourceSets is subject to UE capability. In one embodiment, when SRS resource sets are set with usage set to CB, SRS resources within each set include the same number of SRS antenna ports, whereas different SRS resource sets include a different number of SRS resource sets. In one embodiment, when SRS resource sets are set with usage set to NCB, SRS resource sets include a different number of SRS resources within each set.

In another embodiment, a UE in connection with a base station is disclosed, the UE comprising: at least one antenna port; at least one radio, wherein the at least one radio is configured to communicate with the base station using the at least one antenna port; and at least one processor coupled to the at least one radio, wherein the at least one processor is configured to perform operations comprising: commanding the transmission to the base station of a dynamically determined maximum number of SRS resources for a NCB based PUSCH corresponding to a best panel for UL transmission; or commanding the transmission to the base station of a dynamically determined maximum number of antenna ports for a CB based PUSCH corresponding to a best panel for UL transmission. In one embodiment, the dynamically determined maximum number of SRS resources or antenna ports for NCB or CB based PUSCH are based on physical layer (L1) and are transmitted to the base station in Uplink Control Information (UCI). In one embodiment, the UCI includes at least one of CRI/SSBRI, L1-RSRP/SINR, or Capability Index. In one embodiment, if the transmission is beyond UE capability further comprising the processor commanding: dropping the transmission; transmitting only over antenna ports for CB or the number of SRS resources for NCB that are under the L1 report; or for aperiodic (AP)-SRS defining as an error. In one embodiment, when SRS transmissions correspond to different SRS resource sets with a different number of SRS resources for NCB based or a different number of SRS-Ports for CB based, when SRS transmissions in a particular serving cell overlap in time, further comprising the processor commanding: 1) dropping both SRS transmission occasions; 2) only transmitting over the antenna ports for CB or number of SRS resources for NCB that are under the latest UE L1 capability report, or defining as an error case.

In an additional embodiment, a UE in connection with a base station is disclosed, the UE comprising: at least one antenna port; at least one radio, wherein the at least one radio is configured to communicate with the base station using the at least one antenna port; and at least one processor coupled to the at least one radio, wherein the at least one processor is configured to perform operations comprising: commanding transmission to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs). In one embodiment, the UL UCI includes a pair of trios each including a first trio and a second trio. In one embodiment, the first trio in each pair corresponds to one of the channel measurement resource sets and the second trio in each pair corresponds to the other channel measurement resource sets. In one embodiment, each trio includes at least one of: a CRI associated with the channel measurement resource set; a corresponding RSRP; and a CI associated with the particular beam. In one embodiment, the base station receives indication through the UL UCI of at least the CRI, the L1-RSRP, and instead of the capability index (CI), a UL/DL association. In one embodiment, a single group-based report is provided on the UL UCI that is applicable to both DL for simultaneous reception and UL for simultaneous transmission. In one embodiment, an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6 illustrates a flow diagram of a process to implement functionalities for reporting antenna ports of the UE according to one embodiment of the disclosure.

FIG. 7 illustrates a flow diagram of a process to implement functionalities for reporting antenna ports of the UE according to one embodiment of the disclosure.

FIG. 8 illustrates a flow diagram of a process to implement functionalities to dynamically indicate a group-based capability for a pair of beams according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that arc coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client.” and “device” are intended to refer generally to data processing systems rather than specifically to a particular form factor for the server, client, and/or device.

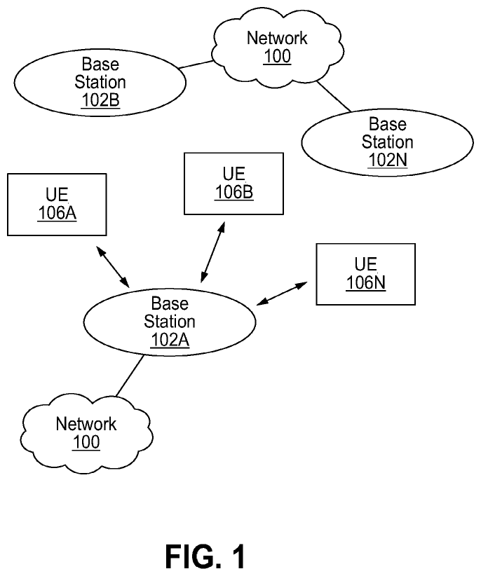

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO. HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice. SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces). LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

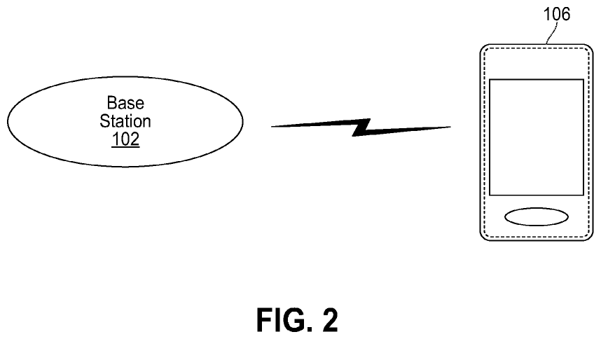

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

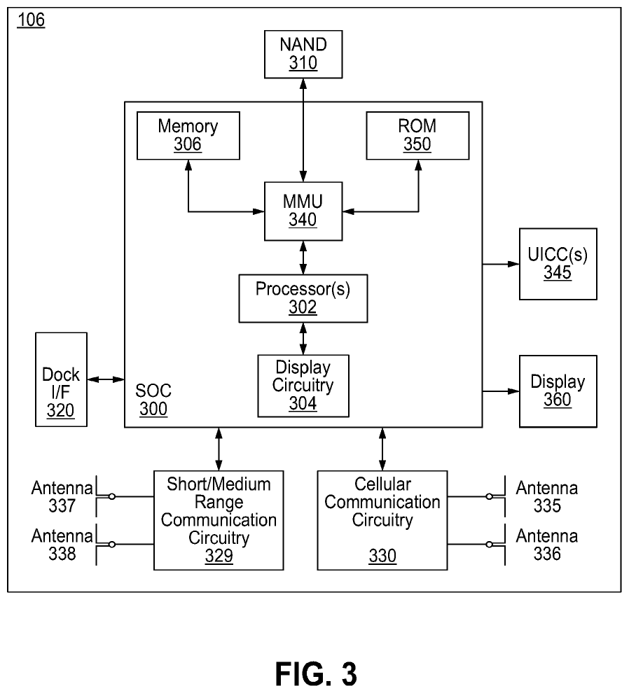

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively: directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively. (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

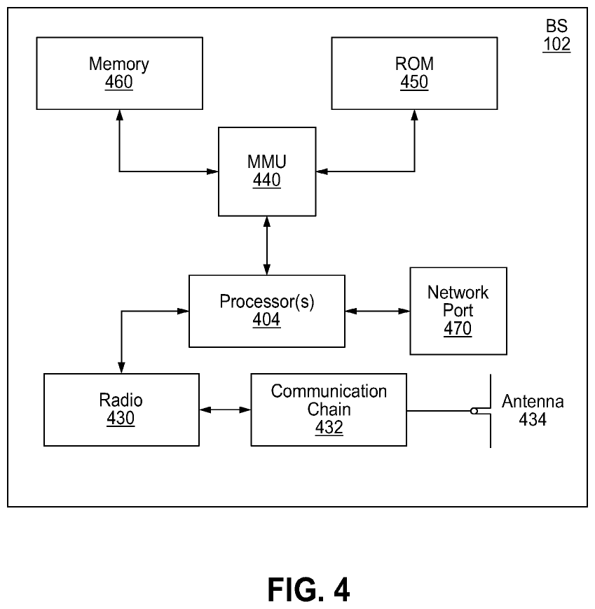

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

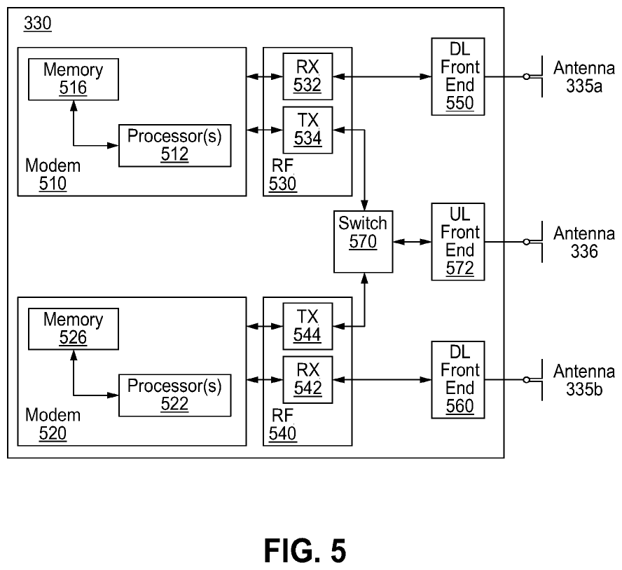

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A. and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

As has been previously described, present implementations in Rel. 17 allow for the UE to indicate (through uplink control information (UCI)), a maximum number of antenna ports, but dynamic UL panel selection is not provided. Also, the present implementations of Rel. 17 do not allow for non-codebook based (NCB) physical uplink channel (PUSCH) transmission. The present implementation in Rel. 17 for UE capability index reporting is only designed to report a maximum number of SRS antenna ports, which is only used for code based (CB) based PUSCH. Furthermore, the present R17 implementation is not applied to multi-panel simultaneous UL transmission. There is no use case for a pair of best panels/beams to be reported by the UE.

Embodiments of the disclosure relate to the UE being able to dynamically indicate a maximum number of antenna ports for the best panel or across panels. Further, embodiments of the disclosure allow for the UE to dynamically indicate a maximum number of sound reference signal (SRS) antenna ports as part of a NCB PUSCH. Moreover, embodiments of the disclosure allow for a multi-panel simultaneous UL transmission providing a use case for a pair of best panels/beams to be reported by the UE.

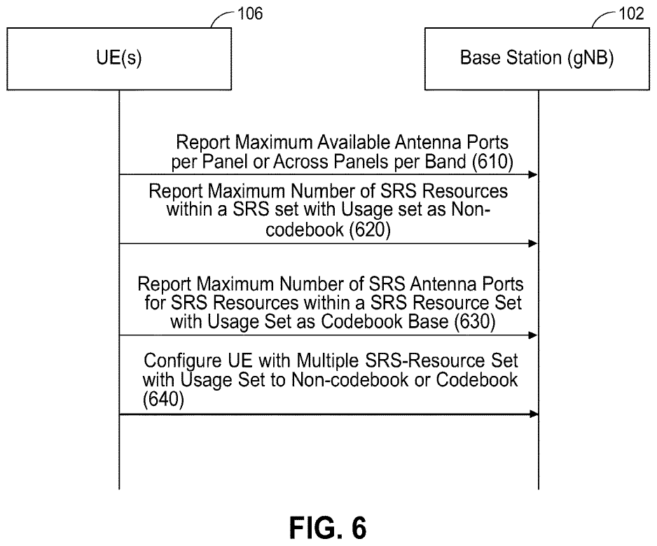

With reference to FIG. 6, FIG. 6 shows a flow diagram of a process to implement radio resource management (RRM) for the UE, and, in particular to provide various new functionalities for reporting antenna ports of the UE. In particular, in one embodiment, a new UE capability is defined, per band, such that, UE 106 can indicate to base station 102 (hereinafter gNB), a maximum number of available antenna ports. As shown in FIG. 6, UE 106 may transmit and report maximum available antenna ports, per panel, or across panels per band to gNB 102 (operation 610). For example, the reported number can be per panel or across panels (e.g., if UE 106 shares digital ports). As an example, candidate values could be (1, 2, 4, 6, 8).

In another embodiment, the existing R17 capability for “UE capability index reporting” may be revised, or, a new capability may be defined, such that the reported number represents either: a maximum number of sounding reference signal (SRS) resources within a SRS resource set with usage set as non-codebook (NCB) based (operation 620), or, a maximum number of SRS antenna ports for SRS resources within a SRS resource set with usage set as codebook (CB) based to gNB 102 (operation 630).

Also, in another embodiment, a new capability may be utilized that only defines maximum number of SRS resources within a SRS resource set with usage set as non-codebook (NCB) based, while the existing R17 capability, “UE capability index reporting” is used for codebook (CB) based PUSCH.

In one embodiment, UE 106 can be configured with multiple SRS-ResourceSets with usage set to ‘nonCodebook’ or a multiple SRS-ResourceSet with usage set to ‘codebook’ (operation 640). Under these implementations, configuration of the multiple SRS-ResourceSet with the same usage docs not necessarily indicate mTRP operation, as it will be described later. For each usage, the number of configured SRS-ResourceSets is subject to UE capability. For each usage, different SRS-ResourceSets can have different resourceTypes (P/SP/AP). For SRS resource sets with usage set to ‘codebook’, SRS resources within each set can have the same number of SRS antenna ports, nrofSRS-Ports (e.g., number of SRS ports), but different SRS resource sets can have different number of nrofSRS-Ports. For SRS resource sets with usage set to ‘nonCodebook’, different SRS-ResourceSets may have different number of SRS resources within each set.

Configurations can be under UE 106 capabilities, as previously described. For example, if a UE 106 reports value 4 (e.g., operation 610), for a CB based PUSCH, UE 106 can be configured with two SRS-ResourceSets with usage set to ‘codebook’, one set has SRS resources with nrofSRS-Ports set to 2 and the other set has SRS resources with nrofSRS-Ports set to 4. It should be noted that the conflict of different SRS resources corresponding to different SRS resource sets, associated to same or different time domain behavior will be discussed in more detail. For example, UE behavior when a AP-SRS (aperiodic-SRS) with 2 antenna ports overlaps in time with a P-SRS (periodic-SRS) with 4 antenna ports.

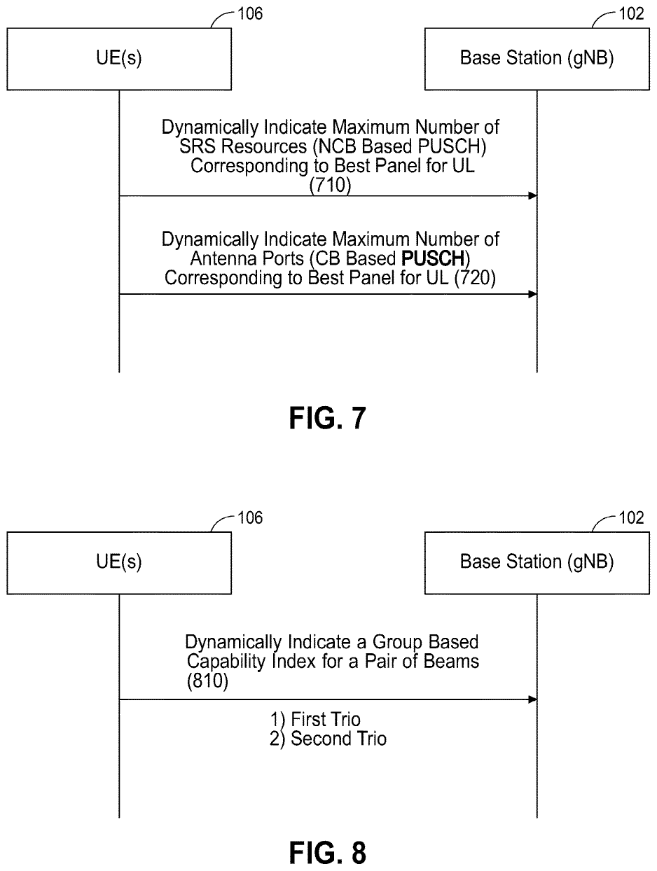

With additional reference to FIG. 7, FIG. 7 shows a flow diagram of a process to implement radio resource management (RRM) for the UE, and, in particular to provide various new functionalities for reporting antenna ports of the UE. In one embodiment, UE 106 dynamically indicates a maximum number of SRS resources (e.g., for a NCB based PUSCH) corresponding to the best panel for UL transmission to gNB 102 (operation 710). Or, in one embodiment, UE 106 dynamically indicates a maximum number of antenna ports (for CB based PUSCH) corresponding to the best panel for UL transmission to gNB 102 (operation 720).

These procedures may be based on L1 measurements and report on UCI similar to existing standards. For example, a N trio of (CRI/SSBRI, L1-RSRP/SINR, CapabilityIndex) is reported in CSI (N is up to 4). New aspects relate to interpreting the “CapabilityIndex” in Rel.17 38.212 to reflect not only CB based PUSCH, but, also, NCB based PUSCH based on capabilities previously described.

For SRS transmission occasions corresponding to a SRS resource set, if transmissions are beyond L1 indicated by the UE capability, previously described. e.g., if the UE 106 dynamically indicates through UL UCI that for a given transmission beam the best panel now has only 2 antenna ports, but UE 106 is configured to transmit periodic SRS with usage set to ‘codebook’, and nrofSRS-Ports set to 4, various options may be implemented: 1) Option 1 is that UE 106 drops the SRS transmission occasion: 2) Option 2 is that UE 106 only transmits over the ports (for CB) or number of SRS resources (for NCB) that are under the latest UE L1 report (in the above example, SRS with 2 antenna ports); or 3) Option 3 is that for AP-SRS, it will be an error case. However, for P/SP-SRS one of the above options can be adopted.

For SRS transmission occasions corresponding to different SRS resource sets with different number of SRS resources (for NCB based) or different nrofSRS-Ports (for CB based), SRS transmissions in a given serving cell may overlap in time. For example, a SRS resource with nrofSRS-Ports set to 4 may overlap with a SRS resource with nrofSRS-Ports set to 2. The following scenario may be considered an error case and shall be avoided by scheduler: At least one of overlapping SRSs is AP-SRS (aperiodic-SRS), and the AP-SRS is beyond L1 indicated by the UE best panel. For the rest of other possible scenarios: 1) Opt1: UE 106 drops both SRS transmission occasions; Opt2: UE 106 only transmits over the ports (for CB) or number of SRS resources (for NCB) that are under the latest UE L1 capability report—For example, if UE 106 dynamically indicates through UL UCI that for a given transmission beam the best panel now has only 2 antenna ports, the UE 106 drops SRS with nrofSRS-Ports set to 4; Opt3: for a UE with capability report as previously described, UE 106 may only be configured with SRS resource sets with resourceType set to be ‘aperiodic’- and for AP-SRS—such collision is not expected/allowed; and Option 4: such collision is considered an error case.

As has been previously described, the procedures for single TRP (sTRP) operations may be CB-based, but similar operations may apply for NCB-based. As has been described, the UE may report maximum number of SRS antenna ports through capability signaling. As has been described, the gNB may configure the UE with multiple SRS resource sets, each with nrofSRS-Ports not more than reported capability (e.g., in 1-1). Further, the UE reports the pair of (CRI/SSBRI, Number of SRS antenna ports) in UL UCI. The number of reported pairs can be 1 or up to 4 depending on the UE capability. The gNB triggers SRS resource sets associated with L1 capability report in the UCI. For example, a SRS resource set with nrofSRS-Ports set to 2 is triggered using DCI format 0_1, 0_2, 1_1, 1_2, or 2_3 (see 38.212, Table 7.3.1.1.2-24: SRS request: Rel.17).

Additional operations for multiple TRPs (mTRP) will be hereafter described. That is, additional changes and improvements to Rel.17 TDM based mTRP and Rel.18 SDM based mTRP operations, will be hereafter described.

In one embodiment process, for mTRP based operation, UE 106 dynamically indicates through UL UCI a group based (CRI/SSBRI, L1-RSRP/SINR, CapabilityIndex). UE 106 is configured with two channel measurement resource sets (similar to group based report for DL). With reference to FIG. 8, UE 106 dynamically indicates a group-based capability for a pair of beams to gNB 102 (operation 810). In particular, UE 106 reports a pair of trios (first trio and second trio) as follows: The first trio in each pair (or as called in DL, resource group) corresponds to one of the channel measurement resource sets; and the 2nd trio in each pair corresponds to the other channel measurement resource sets. The 1-bit resource set indicator in the CSI report indicates the 1st or the 2nd channel measurement resource set with value of 0 or 1, respectively. Each trio consists of the followings: CRI (or SSBRI) associated to the indicated channel measurement resource set; Corresponding RSRP (or SINR); Different from DL, a CapabilityIndex associated to that specific beam.

Example components (CSI report numbers and CSI fields—for just two pairs) will be discussed hereafter and can be seen in the example table below.

It should be noted that if UE 106 is RRC configured with SDM/SFN based (e.g., Rel.18) mTRP operation, the dynamic CSI report indicates UE 106 is capable to transmit simultaneously on the beams associated by CSI/SSBRI corresponding to each pair if UE 106 is RRC configured with TDM based (e.g., Rel.17) mTRP operation, the dynamic CSI report indicates the indicated beams can be used for TDM operation. If neither SDM/SFN or TDM is configured, the previously described sTRP operation may be applied

An example of table to support the CSI report numbers and CSI fields is produced below:

| CSI report | |
|---|---|
| number | CSI fields |
| CSI report #n | Resource set indicator |
| | CRI or SSBRI #1 of 1st resource group as in Table 6.3.1.1.2-6, if reported |
| | CRI or SSBRI #2 of 1st resource group as in Table 6.3.1.1.2-6, if reported |
| | CRI or SSBRI #1 of 2nd resource group as in Table 6.3.1.1.2-6, if reported |
| | CRI or SSBRI #2 of 2nd resource group as in Table 6.3.1.1.2-6, if reported |
| | RSRP of CRI or SSBRI #1 of 1st resource group as in Table 6.3.1.1.2-6 |
| | Differential RSRP of CRI or SSBRI #2 of 1st resource group as in Table 6.3.1.1.2-6 |
| | Differential RSRP of CRI or SSBRI #1 of 2nd resource group as in Table 6.3.1.1.2-6, if reported |
| | Differential RSRP of CRI or SSBRI #2 of 2nd resource group as in Table 6.3.1.1.2-6, if reported |
| | [symbol] |
| | [symbol] |
| | [symbol] |
| | [symbol] |

[symbol]

indicates data missing or illegible when filed

In another embodiment, for mTRP based operation, UE 106 dynamically indicates through UL UCI a group based (CRI/SSBRI, L1-RSRP/SINR, and UL/DL association).

The procedure is similar the previously discussed procedure, unless it assumes both panels always have the same and fixed capabilities so that CapabilityIndex is not reported. Under this proposal, a single group-based report is provided on UL UCI which is potentially applicable to both DL (for simultaneous reception) and UL (for simultaneous transmission). The indication is given by UL/DL association which has 1 or two bits (per pair) as follows: Two bits: 00 (DL only), 01 (UL only), 10 (applicable to both UL & DL), 11 (reserved); and 1 bits: 0 (DL only), 1 (applicable to both UL & DL).

An example table can be seen below (for just two pairs):

| CSI report | |
|---|---|
| number | CSI fields |
| CSI report #n | Resource set indicator |
| | CRI or SSBRI #1 of 1st resource group as in Table 6.3.1.1.2-6, if reported |
| | CRI or SSBRI #2 of 1st resource group as in Table 6.3.1.1.2-6, if reported |
| | CRI or SSBRI #1 of 2nd resource group as in Table 6.3.1.1.2-6, if reported |
| | CRI or SSBRI #2 of 2nd resource group as in Table 6.3.1.1.2-6, if reported |
| | RSRP of CRI or SSBRI #1 of 1st resource group as in Table 6.3.1.1.2-6 |
| | Differential RSRP of CRI or SSBRI #2 of 1st resource group as in Table 6.3.1.1.2-6 |
| | Differential RSRP of CRI or SSBRI #1 of 2nd resource group as in Table 6.3.1.1.2-6, if reported |
| | Differential RSRP of CRI or SSBRI #2 of 2nd resource group as in Table 6.3.1.1.2-6, if reported |
| | [symbol] |
| | [symbol] |

[symbol]

indicates data missing or illegible when filed

It should be appreciated that the operations of the previously described processes in some embodiments may be performed: at the UE 106 including: a processor, communication interfaces, antenna ports, a radio, etc., to implement the previously described processes; and/or at the base station (e.g., gNB) 102 including: a processor, communication interfaces, antenna ports, a radio, etc., to implement the previously described processes.

There is a number of example embodiments described herein.

Example 1 is a method for radio resource management (RRM) for a user equipment (UE) in communication with a base station including: determining a maximum number of available antenna ports per panel per band; and transmitting from the UE to the base station the maximum number of available antenna ports per panel per band.

Example 2 is the method of example 1 that may optionally include transmitting from the UE to the base station a maximum number of available antenna ports per band across panels.

Example 3 is a method for radio resource management (RRM) for a user equipment (UE) in communication with a base station including: transmitting from the UE to the base station a UE capability index report including a maximum number of sounding reference signal (SRS) resources within a SRC resource set with usage set as non-codebook (NCB) based or a maximum number of SRS resources within a SRC resource set with usage set as codebook (CB) based.

Example 4 is a method for radio resource management (RRM) for a user equipment (UE) in communication with a base station comprising: configuring multiple SRS-ResourceSets with usage set to NCB at the UE or a multiple SRS-ResourceSet with usage set to CB at the UE.

Example 5 is the method of example 4 that may optionally include that the number of configured SRS-ResourceSets is subject to UE capability.

Example 6 is the method of example 5 that may optionally include that when SRS resource sets are set with usage set to CB, SRS resources within each set include the same number of SRS antenna ports, whereas different SRS resource sets include a different number of SRS resource sets.

Example 7 is the method of example 6 that may optionally include that, when SRS resource sets are set with usage set to NCB, SRS resource sets include a different number of SRS resources within each set.

Example 8 is a method for radio resource management (RRM) for a user equipment (UE) in communication with a base station including: transmitting from the UE to the base station a dynamically determined maximum number of SRS resources for a NCB based physical uplink channel (PUSCH) corresponding to a best panel for UL transmission; or transmitting from the UE to the base station a dynamically determined maximum number of antenna ports for a CB based PUSCH corresponding to a best panel for UL transmission.

Example 9 is the method of example 8 that may optionally include that the dynamically determined maximum number of SRS resources or antenna ports for NCB or CB based PUSCH are based on physical layer (L1) and are transmitted to the base station in Uplink Control Information (UCI).

Example 10 is the method of example 9 that may optionally include that the UCI includes at least one of CRI/SSBRI, L1-RSRP/SINR, or Capability Index.

Example 11 is the method of example 9 that may optionally include that if the transmission is beyond UE capability further comprising: dropping the transmission; transmitting only over antenna ports for CB or the number of SRS resources for NCB that are under the L1 report; or for aperiodic (AP)-SRS defining as an error.

Example 12 is the method of example 9 that may optionally include that when SRS transmissions correspond to different SRS resource sets with a different number of SRS resources for NCB based or a different number of SRS-Ports for CB based, when SRS transmissions in a particular serving cell overlap in time, further comprising: 1) dropping both SRS transmission occasions; 2) only transmitting over the antenna ports for CB or number of SRS resources for NCB that are under the latest UE L1 capability report; or defining as an error case.

Example 13 is a method for radio resource management (RRM) for a user equipment (UE) in communication with a base station including: transmitting from the UE to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs).

Example 14 is the method of example 13 that may optionally include that the UL UCI includes a pair of trios each including a first trio and a second trio.

Example 15 is the method of example 14 that may optionally include that the first trio in each pair corresponds to one of the channel measurement resource sets and the second trio in each pair corresponds to the other channel measurement resource sets.

Example 16 is the method of example 15 that may optionally include that each trio includes at least one of: a CRI associated with the channel measurement resource set; a corresponding RSRP; and a CI associated with the particular beam.

Example 17 is the method of example 13 that may optionally include that the UE dynamically indicates to the base station through the UL UCI at least the CRI, the L1-RSRP, and instead of the capability index (CI), a UL/DL association.

Example 18 is the method of example 17 that may optionally include that a single group-based report is provided on the UL UCI that is applicable to both DL for simultaneous reception and UL for simultaneous transmission.

Example 19 is the method of example 18 that may optionally include that an indication provided for UL/DL association by two or one bits (per pair) includes for two bits: 00 (DL only), 01 (UL only), 10 (applicable to both UL & DL), and 11 (reserved): or for one bit: 0 (DL only), and 1 (applicable to both UL & DL).

Example 20 is a user equipment (UE) to implement radio resource management (RRM) for the UE, the UE in connection with a base station, the UE including: at least one antenna port: at least one radio, wherein the at least one radio is configured to communicate with the base station using the at least one antenna port; and at least one processor coupled to the at least one radio, wherein the at least one processor is configured to perform operations including: determining a maximum number of available antenna ports per panel per band; and commanding transmission to the base station of the maximum number of available antenna ports per panel per band.

Example 21 is the UE of example 20 that may optionally include the processor commanding the transmission to the base station a maximum number of available antenna ports per band across panels.

Example 22 is a user equipment (UE) to implement radio resource management (RRM) for the UE, the UE in connection with a base station, the UE including: at least one antenna port: at least one radio, wherein the at least one radio is configured to communicate with the base station using the at least one antenna port; and at least one processor coupled to the at least one radio, wherein the at least one processor is configured to perform operations including: commanding transmission to the base station of a UE capability index report including a maximum number of sounding reference signal (SRS) resources within a SRC resource set with usage set as non-codebook (NCB) based or a maximum number of SRS resources within a SRC resource set with usage set as codebook (CB) based.

Example 23 is a user equipment (UE) to implement radio resource management (RRM) for the UE, the UE in connection with a base station, the UE including: at least one antenna port; at least one radio, wherein the at least one radio is configured to communicate with the base station using the at least one antenna port; and at least one processor coupled to the at least one radio, wherein the at least one processor is configured to perform operations including: configuring multiple SRS-ResourceSets with usage set to NCB or a multiple SRS-ResourceSet with usage set to CB.

Example 24 is the UE of example 23 that may optionally include that the number of configured SRS-ResourceSets is subject to UE capability.

Example 25 is the UE of example 24 that may optionally include that when SRS resource sets are set with usage set to CB. SRS resources within each set include the same number of SRS antenna ports, whereas different SRS resource sets include a different number of SRS resource sets.

Example 26 is the UE of example 1 that may optionally include that when SRS resource sets are set with usage set to NCB, SRS resource sets include a different number of SRS resources within each set.

Example 27 is a user equipment (UE) to implement radio resource management (RRM) for the UE, the UE in connection with a base station, the UE including: at least one antenna port; at least one radio, wherein the at least one radio is configured to communicate with the base station using the at least one antenna port; and at least one processor coupled to the at least one radio, wherein the at least one processor is configured to perform operations including: commanding the transmission to the base station of a dynamically determined maximum number of SRS resources for a NCB based PUSCH corresponding to a best panel for UL transmission; or commanding the transmission to the base station of a dynamically determined maximum number of antenna ports for a CB based PUSCH corresponding to a best panel for UL transmission.

Example 28 is the UE of example 27 that may optionally include that the dynamically determined maximum number of SRS resources or antenna ports for NCB or CB based PUSCH are based on physical layer (L1) and are transmitted to the base station in Uplink Control Information (UCI).

Example 29 is the UE of example 28 that may optionally include that the UCI includes at least one of CRI/SSBRI, L1-RSRP/SINR, or Capability Index.

Example 30 is the UE of example 28 that may optionally include that if the transmission is beyond UE capability further comprising the processor commanding: dropping the transmission; transmitting only over antenna ports for CB or the number of SRS resources for NCB that are under the L1 report; or for aperiodic (AP)-SRS defining as an error.

Example 31 is the UE of example 28 that may optionally include that when SRS transmissions correspond to different SRS resource sets with a different number of SRS resources for NCB based or a different number of SRS-Ports for CB based, when SRS transmissions in a particular serving cell overlap in time, further comprising the processor commanding: 1) dropping both SRS transmission occasions; 2) only transmitting over the antenna ports for CB or number of SRS resources for NCB that are under the latest UE L1 capability report; or defining as an error case.

Example 32 is a user equipment (UE) to implement radio resource management (RRM) for the UE, the UE in connection with a base station, the UE including: at least one antenna port; at least one radio, wherein the at least one radio is configured to communicate with the base station using the at least one antenna port; and at least one processor coupled to the at least one radio, wherein the at least one processor is configured to perform operations including: commanding transmission to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs).

Example 33 is the UE of example 32 that may optionally include that the UL UCI includes a pair of trios each including a first trio and a second trio.

Example 34 is the UE of example 33 that may optionally include that the first trio in each pair corresponds to one of the channel measurement resource sets and the second trio in each pair corresponds to the other channel measurement resource sets.

Example 35 is the UE of example 34 that may optionally include that each trio includes at least one of: a CRI associated with the channel measurement resource set; a corresponding RSRP; and a CI associated with the particular beam.

Example 36 is the UE of example 32 that may optionally include that the base station receives indication through the UL UCI of at least the CRI, the L1-RSRP, and instead of the capability index (CI), a UL/DL association.

Example 37 is the UE of example 36 that may optionally include that a single group-based report is provided on the UL UCI that is applicable to both DL for simultaneous reception and UL for simultaneous transmission.

Example 38 is the UE of example 37 that may optionally include that an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).

Example 39 is a baseband processor configured to perform operations of any of examples 1-19.

Example 40 is a UE configured to perform operations of any of examples 1-19.

Example 41 is an article of manufacture having one or more non-transitory computer readable media storing instructions which, when executed by a baseband processor or a UE, cause the baseband processor or UE to perform a method comprising the operations of any of examples 1-19.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the previously described embodiment operations may be stored as instructions on a non-transitory computer readable medium for execution by a computer (e.g., a UE). The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media: flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs. DVD ROMs, EPROMs. EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1-12. (canceled)

13. A method for radio resource management (RRM) for a user equipment (UE) in communication with a base station comprising:
transmitting from the UE to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs).

14. The method of claim 13, wherein, the UL UCI includes a pair of trios each including a first trio and a second trio.

15. The method of claim 14, wherein, the first trio in each pair corresponds to one of the channel measurement resource sets and the second trio in each pair corresponds to the other channel measurement resource sets.

16. The method of claim 15, wherein, each trio includes at least one of:
a CRI associated with the channel measurement resource set;
a corresponding RSRP; and
a CI associated with the particular beam.

17. The method of claim 13, wherein, the UE dynamically indicates to the base station through the UL UCI at least the CRI, the L1-RSRP, and instead of the capability index (CI), a UL/DL association.

18. The method of claim 17, wherein, a single group-based report is provided on the UL UCI that is applicable to both DL for simultaneous reception and UL for simultaneous transmission.

19. The method of claim 18, wherein, an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).

20-31. (canceled)

32. A user equipment (UE) to implement radio resource management (RRM) for the UE, the UE in connection with a base station, the UE comprising:
at least one antenna port;
at least one radio, wherein the at least one radio is configured to communicate with the base station using the at least one antenna port; and
at least one processor coupled to the at least one radio, wherein the at least one processor is configured to perform operations comprising:
commanding transmission to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs).

33. The UE of claim 32, wherein, the UL UCI includes a pair of trios each including a first trio and a second trio.

34. The UE of claim 33, wherein, the first trio in each pair corresponds to one of the channel measurement resource sets and the second trio in each pair corresponds to the other channel measurement resource sets.

35. The UE of claim 34, wherein, each trio includes at least one of:
a CRI associated with the channel measurement resource set;
a corresponding RSRP; and
a CI associated with the particular beam.

36. The UE of claim 32, wherein, the base station receives indication through the UL UCI of at least the CRI, the L1-RSRP, and instead of the capability index (CI), a UL/DL association.

37. The UE of claim 36, wherein, a single group-based report is provided on the UL UCI that is applicable to both DL for simultaneous reception and UL for simultaneous transmission.

38. The UE of claim 37, wherein, an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).

39. A non-transitory computer-readable storage medium, comprising instructions that, when executed by one or more processors of a user equipment (UE), cause the UE to:
transmit from the UE to the base station through dynamic uplink (UL) Uplink Control Information (UCI) including at least a CSI-RS Resource Indicator (CRI), a L1-Reference Signal Received Power (RSRP), and a capability index (CI) for at least a pair of beams for a group of multiple transmission and reception points (mTRPs).

40. The non-transitory computer-readable storage medium of claim 39, wherein, the UL UCI includes a pair of trios each including a first trio and a second trio.

41. The non-transitory computer-readable storage medium of claim 40, wherein, the first trio in each pair corresponds to one of the channel measurement resource sets and the second trio in each pair corresponds to the other channel measurement resource sets.

42. The non-transitory computer-readable storage medium of claim 41, wherein, each trio includes at least one of:
a CRI associated with the channel measurement resource set;
a corresponding RSRP; and
a CI associated with the particular beam.

43. The non-transitory computer-readable storage medium of claim 39, wherein, the UE dynamically indicates to the base station through the UL UCI at least the CRI, the L1-RSRP, and instead of the capability index (CI), a UL/DL association.

44. The non-transitory computer-readable storage medium of claim 43, wherein, a single group-based report is provided on the UL UCI that is applicable to both DL for simultaneous reception and UL for simultaneous transmission.

45. The non-transitory computer-readable storage medium of claim 44, wherein, an indication provided for UL/DL association by two or one bits (per pair) includes for two bits: 00 (DL only), 01 (UL only), 10 (applicable to both UL & DL), and 11 (reserved); or for one bit: 0 (DL only), and 1 (applicable to both UL & DL).
